(19) United States
(12) Patent Application Publication
(10) Pub. No.: US 2023/0165194 A1
(43) Pub. Date: Jun. 1, 2023

(54) In-Situ Harvesting and Processing

(71) Applicant: Jing-Yau Chung, Houston, TX (US)

(72) Inventor: Jing-Yau Chung, Houston, TX (US)

(21) Appl. No.: 18/072,342

(22) Filed: Nov. 30, 2022

Related U.S. Application Data
(60) Provisional application No. 63/284,377, filed on Nov. 30, 2021.

(51) Int. Cl. A01D 90/12; A01D 45/22; A01D 59/02

(52) U.S. Cl. CPC A01D 90/12; A01D 45/22; A01D 59/02

(57) ABSTRACT

A system for processing a crop that is harvested from a field is disclosed. The system includes sorting the crop in-situ, washing the crop in-situ, blanching the crop in-situ, freezing the crop in-situ; and packaging the crop in-situ. The crop may comprise edamame pods.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### BACKGROUND

Technical Field: The technical field is directed to harvesting and processing of agriculture crop such as edamame pods and others of similar shape and size that is to be frozen for delivery to another location or facility, and equipment for same.

### BRIEF SUMMARY

The present technology and at least one aspect of the invention is related to several new devises which are linked together to form a new in-situ agriculture harvesting system. This new mechanical system performs in-situ processing and packaging of the crop such as edamame at the harvesting site.

The in-situ agriculture harvesting system is more efficient by at least saving on transportation and cooling. The in-situ agriculture harvesting system also results in a product having relatively greater freshness, a relatively better taste, and a relatively higher quality (e.g., by way of example, color, taste, smell, and/or crispiness).

As used herein, “IQF” may be defined as “individually quick freeze”. As used herein, “in-situ” may be defined as at or in the crop field, within the boundaries of the crop field, or near or proximate the crop field to be harvested (proximate as in, such as by way of example only, an adjacent road or access area), and not requiring transport to a processing plant for purposes of washing, blanching, freezing, and/or, at least, bulk packing.

### BRIEF DESCRIPTION OF DRAWINGS

The embodiments may be better understood, and numerous objects, features, and advantages made apparent to those skilled in the art by referencing the accompanying drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 depicts a side elevational view of a rotating drum sorter.

FIG. 2 depicts a side elevational view of an edamame washing system.

FIG. 3 depicts a side elevational view of an edamame blanching system.

FIG. 4 depicts a side elevational view of an IQF freeze tunnel system.

FIG. 5 depicts a side elevational view of a packaging IQF edamame into product bin schematic.

FIG. 6 combines FIG. 4 and FIG. 5 and depicts a side elevational view of an IQF edamame packed in bins to be transported out of the harvesting system.

FIG. 7 depicts a side elevational view of each processing system on a trailer to be transported by the tractor.

FIG. 8 depicts a schematic side elevational view of the in-situ harvesting and processing system.

### DETAILED DESCRIPTION

The description that follows includes exemplary apparatus, methods, techniques, and instruction sequences that embody techniques of the inventive subject matter. However, it is understood that the described embodiments may be practiced without these specific details.

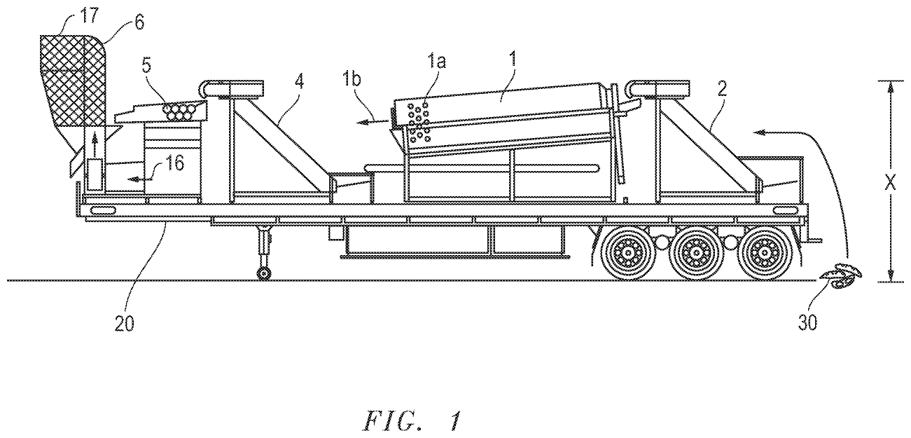

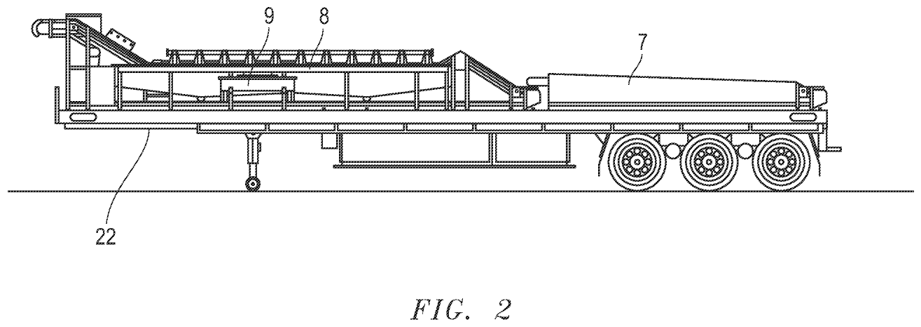

With reference to FIG. 1, a drum sorter 1 receives the edamame pods 30 (or other like crop as discussed below), for example, from a combined hopper and incline conveyor 2. The drum sorter 1 may be a rotating cylindrical drum having a plurality of holes 1a defined by the surface of said drum sorter 1 which allow edamame pods 30 to drop, pass, or travel through. The rotating drum sorter 1 sorts out unwanted sticks and leaves by means of multiple holes 1a on the rotating drum sorter where only the edamame pods drop through the multiple holes. The said unwanted sticks and leaves are then discarded as shown by the arrow 1b at the end of the drum with or without the help of baffles built on the wall of the drum. The selected edamame pods being dropped out of the drum and being conveyed by the incline conveyor 4 are discharged to a brush roller 5. All abovementioned mechanisms can be constructed, for example, on an open-bed trailer 20 shown in FIG. 1 (or on a similar custom platform). The output of brush roller 5 is then fed into the blower-cleaner 6, having air in 16, before being input to the second section shown in FIG. 2. Blower-cleaner 6 may have a portion 17 to be assembled in situ when in use (if necessary due to highway height limit X).

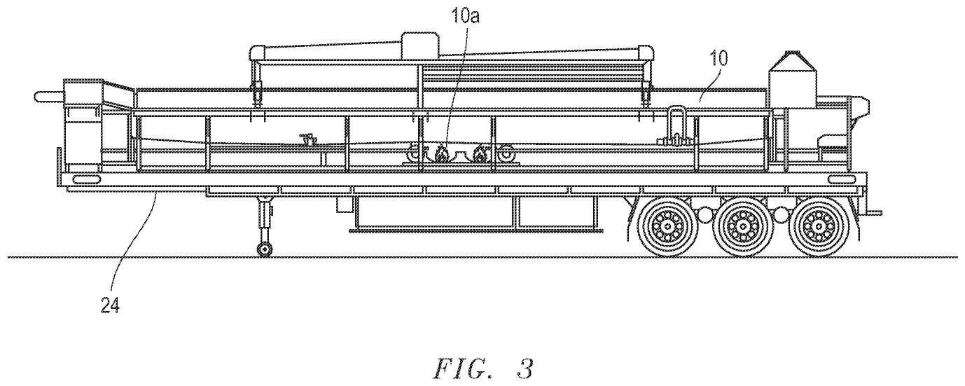

With reference to FIG. 2, the edamame pods are conveyed through the transfer conveyor 7 which transfers the edamame pods to a wash tank 8. The water used in the wash tank 8 is cleaned and purified continuously or constantly by a filtration system 9. All abovementioned mechanisms can be constructed, for example, on a trailer 22 shown in FIG. 2 (or on a similar custom platform). The edamame pods after being washed are then transferred to the next section shown in FIG. 3.

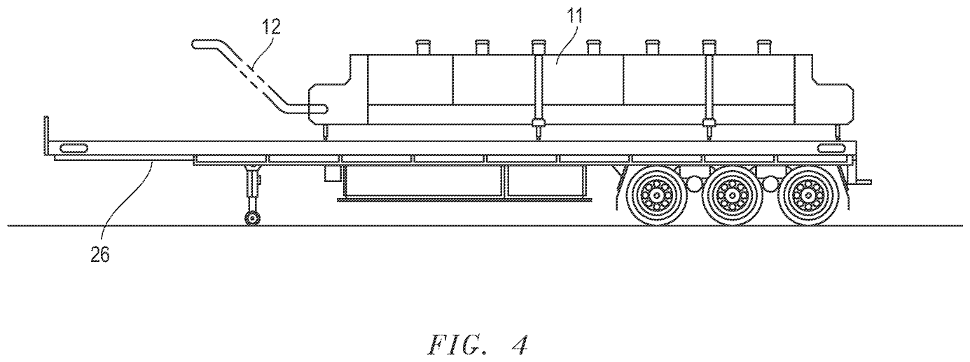

With reference to FIG. 3, the edamame is poured into a blancher 10 which is filled with hot water being heated by the burner 10a. During and after the edamame pods are blanched, they are moved forward by a spiral conveyor inside the blancher (not shown). The above mentioned blancher system can be constructed, for example, on a trailer 24 shown in FIG. 3 (or on a similar custom platform). The blanched edamame pods are then outputted to the next section shown in FIG. 4 where the edamame pods are individually quick frozen.

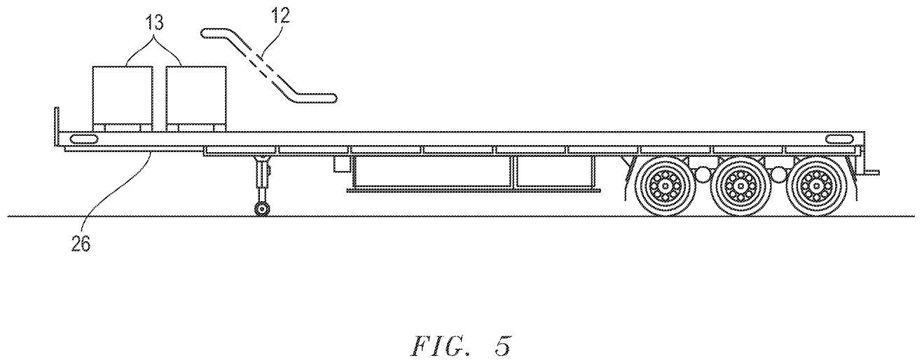

With reference to FIG. 4, a multiple number of freeze tunnel are linked in series to form a quick freeze tunnel system 11 as depicted. Liquid nitrogen or liquid carbon-dioxide, for example or other cooling means is used to individually quick freeze the edamame pods. The individually quick frozen (IQF) edamame pods are then transported by the incline conveyor 12 to the packaging section where the IQF edamame pods are poured into product bin 13 in the packaging section shown in FIG. 5.

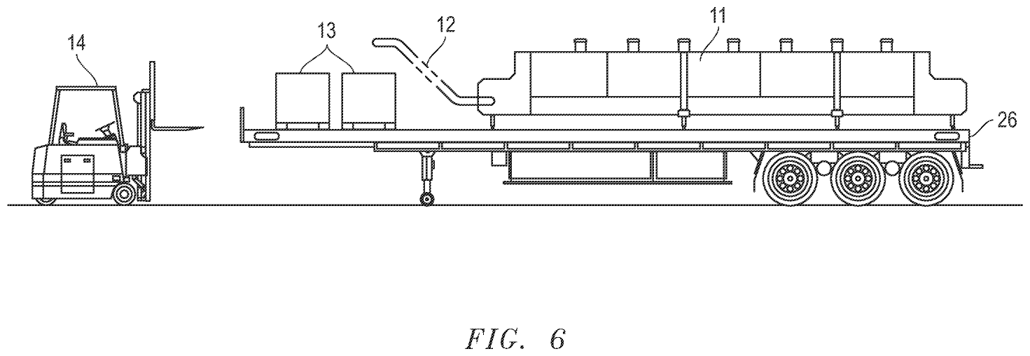

FIG. 6 shows a combined quick freeze and packaging sections that can be constructed, for example, on a trailer 26 (or on a similar custom platform). The IQF edamame being packaged and sealed in the product bin 13 as described above can be moved out of the harvest system by means of, e. g. a forklift 14 as depicted. The forklift may be used in a sequence for moving bulk packaging to a truck for transporting to other facilities for further and final packaging, to an appropriate storage device or facility, or to a customer.

Optionally, the IQF edamame being transported out of conveyor 12 can be stored in another trailer (not shown) for a quality sorting by means of, for example, an optical sorter. The foreign objects and unwanted edamame pods, such as “a pod with no bean”, “a single-bean pod”, “a discolored pod (e.g., yellowish pod)”, “an irregular shaped pod” are rejected automatically by the optical sorter before the selected edamame are fed into, for example, a standard automatic portioning machine. The edamame is then portioned out into desirable unit weight to be further packaged into, for example, an individual retail package. All these optional processes mentioned above can be accomplished in full automation by means of currently available automatic machinery.

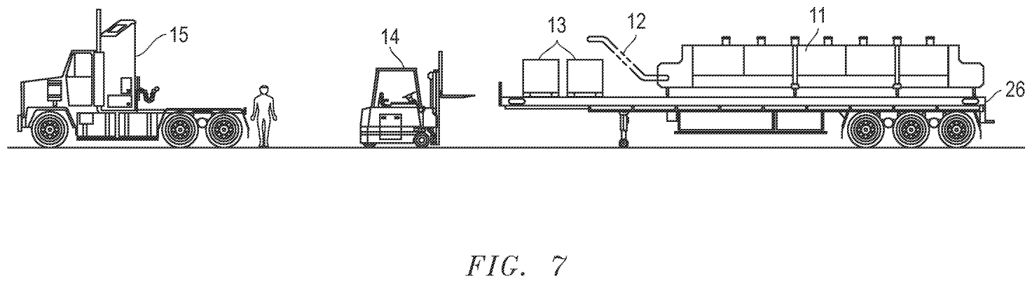

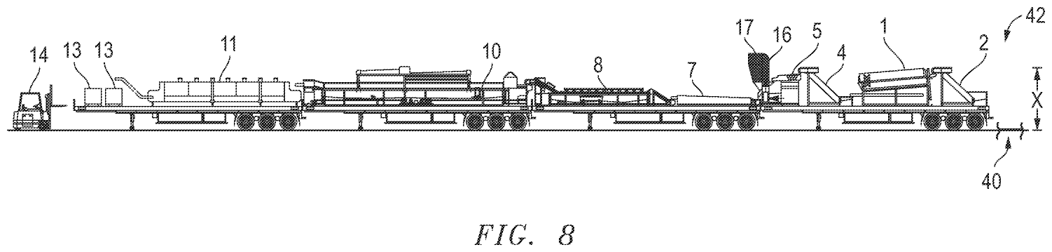

As mentioned above, the mechanical devises in each section shown in FIGS. 1, 2, 3, 4 and 6 can be constructed, for example, on an open-bed eighteen-wheeler trailer or otherwise, a modified custom trailer. Each trailer or a combination of trailers, for example, can be towed by the tractor 15 depicted in FIG. 7. FIG. 8 depicts the overall in-situ harvesting system by linking all sections in series. The overall in-situ harvesting system is depicted schematically in-situ 42 in relation to a crop field 40.

The crop to be processed by this technology and invention is not limited to that of edamame. Other types of agriculture crop similar in shape and size of edamame pod, such as green bean, sweet pea, etc. or larger size fruits such as tomato, eggplant etc. or even smaller size berries and grains can be processed by the system with or without modification of the system.

Any or all of the trailers 22, 24, and 26 may, for example in one embodiment, comprise an enclosure for the food safety reasons, such as may be required in the United States or other jurisdictions for food processing. Such an enclosure may comprise a regular commercial trailer having the size of a standard regular trailer which is ideal for highway transport (e.g. within the limits of highway height limit X shown in FIG. 1, for example within twelve feet eight inches). By way of example only, the distance between the top of trailer 20 in FIG. 1 and the top of the highway height limit X may be eight feet. Any or all of the trailers 20, 22, 24, 26 when in use in-situ should be connected via a removable sealed enclosure-type connection between each or all of the trailers 20, 22, 24, 26. The purpose is to prevent exposure of the crop product to the outside environment such that the crop product can be moved from one trailer section to the next sequential trailer without exposing to the outside air, at least, from after washing of the crop to before packaging of the crop product. Any or all of the trailers 20, 22, 24, 26 or a similar custom platform may be an autonomous custom platform and/or vehicle, and may incorporate artificial intelligence for transport and/or location/placement.

The disclosure and content, including the specification and drawings, of U.S. Provisional Application No. 63/284,377, filed Nov. 30, 2021, entitled ‘In-Situ Harvesting and Processing’ is hereby incorporated by reference. The disclosure and content, including the specification and drawings, of U.S. Provisional Application No. 63/341,662, filed May 13, 2022, entitled ‘Automatic Mechanical System in Mass Production Indoor Planting with Soil’ is hereby incorporated by reference (the present in-situ harvesting system disclosed can be located in-situ 42, for example, inside or proximate such a system for mass indoor production of a plant or a greenhouse).

While the embodiments are described with reference to various implementations and exploitations, it will be understood that these embodiments are illustrative and that the scope of the inventive subject matter is not limited to them. Many variations, modifications, additions, and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A method for processing a crop that is harvested from a field, comprising the steps of:
sorting the crop in-situ;
washing the crop in-situ;
blanching the crop in-situ;
freezing the crop in-situ; and
packaging the crop in-situ.

2. The method according to claim 1, wherein the crop is a plurality of edamame pods.

3. The method according to claim 1, wherein the steps sorting the crop in-situ, washing the crop in-situ, blanching the crop in-situ, freezing the crop in-situ, and packaging the crop in-situ are all performed on at least one open-bed trailer or a similar custom platform mounted and situated in-situ.

4. The method according to claim 2, wherein the steps sorting the crop in-situ, washing the crop in-situ, blanching the crop in-situ, freezing the crop in-situ, and packaging the crop in-situ are all performed on at least one open-bed trailer or a similar custom platform mounted and situated in-situ.

5. An apparatus for processing a crop that is harvested from a field, comprising:
a sorting system mounted in-situ;
a washing system mounted in-situ and connected to the sorting system;
a blanching system mounted in-situ and connected to the washing system;
a freezing system mounted in-situ and connected to the blanching system; and
a packaging system mounted in-situ and connected to the freezing system.

6. The apparatus according to claim 5, wherein the crop is a plurality of edamame pods.

7. The apparatus according to claim 5, further comprising at least one open-bed trailer or a similar custom platform mounted in-situ and supporting the sorting system, the washing system, the blanching system, the freezing system, and the packaging system.

8. The apparatus according to claim 6, further comprising at least one open-bed trailer or a similar custom platform mounted in situ and supporting the sorting system, the washing system, the blanching system, the freezing system, and the packaging system.

9. The apparatus according to claim 7, wherein the one open-bed trailer or a similar custom platform comprises a plurality of open-bed trailers.

10. The apparatus according to claim 8, wherein the one open-bed trailer or a similar custom platform comprises a plurality of open-bed trailers.
